(19) United States
(12) Patent Application Publication
(10) Pub. No.: US 2013/0132552 A1
(43) Pub. Date: May 23, 2013

(54) Application-Aware Quality Of Service In Network Applications

(71) Applicant: International Business Machines Corporation, Armonk, NY (US)

(72) Inventors: Simon Gilbert Canning, Upper Coomera (AU); Scott Anthony Exton, Ormeau Hills (AU); Neil Ian Readshaw, Parkwood (AU)

(73) Assignee: International Business Machines Corporation, Armonk, NY (US)

(21) Appl. No.: 13/740,494

(22) Filed: Jan. 14, 2013

Related U.S. Application Data
(63) Continuation of application No. 13/231,253, filed on Sep. 13, 2011.

(51) Int. Cl. H04L 29/06

(52) U.S. Cl. CPC H04L 65/80
USPC 709/223; 715/234

(57) ABSTRACT

An approach is provided in which a number of requests are received from a variety of clients over a computer network. The system uses a processor to calculate request priority values pertaining to the received requests. The calculation of the request priority values is based on one or more attributes that correspond to the respective requests. For example, the attributes could include network level attributes, session attributes, and application specific attributes. Each of the requests is assigned a request priority value. A request may receive the same request priority value as other requests. The requests are queued in a memory based on the request priority values that were assigned to the requests. The queued requests are then serviced in order of request priority so that queued requests assigned higher request priority values are processed before queued requests with lower request priority values.

### TECHNICAL FIELD

The present disclosure relates to an approach that provides application-aware Quality of Service (QoS) in network environments. More particularly, the present invention provides an approach that calculates a client request priority based on a variety of factors.

### BACKGROUND OF THE INVENTION

In a typical distributed/network computing environment, service requests arrive at servers from a number of client systems. This may use one of a number of application protocols, such as HTTP, FTP, etc, and protocols or data formats above that, e.g. XML/SOAP web services, RESTful web services. The relative importance of individual requests may depend upon a number of factors. These factors include: (a) the location from which the request originated, e.g. source IP address or domain, etc.; (b) whether the request seems malicious or may exploit a known vulnerability; (c) attributes of the user/identity making the request, where the application protocol semantics have this concept, e.g. users who have authenticated with a strong form of authentication or users within a particular group, etc.; (d) attributes of the user session, where session semantics are present in the protocol, e.g. the frequency of requests in the user session, total number of requests in a session, etc.; (e) addressing data in the request, e.g. URL, file system path, etc.; and (f) application-specific semantics, e.g. the user is midway through a revenue generating or multi-step transaction, etc.

Based on business requirements in a given environment, a combination of factors above may result in a desire to prioritize the processing of service requests, sometimes referred to as “Quality of Service” or “QoS.” Network security devices often contain a subset of these capabilities in the form of intrusion prevention and universal threat management. However these capabilities are normally focused on identifying known threats and mitigating them, or based on request attributes visible at the network level, e.g. client IP address, etc. The response from these network security devices is often coarse grained, e.g. simply rejecting the requests, etc. Traditional solutions therefore often result in a binary form of quality of service (e.g., accept or deny the request, etc.). Application proxies and application servers often attempt to provide some form of flow control, based on gross measurements such as overall utilization of system (e.g. CPU, network, etc.) or internal resources (e.g. number of threads in the pool available to process requests inside a web application proxy, etc.). However, the approaches taken by application proxies and application servers may “throttle” requests indiscriminately, and, consequently, ignore the majority of the factors mentioned above.

### SUMMARY

An approach is provided in which a number of requests are received from a variety of clients over a computer network. The system uses a processor to calculate request priority values pertaining to the received requests. The calculation of the request priority values is based on one or more attributes that correspond to the respective requests. For example, the attributes could include network level attributes that correspond to the respective requests, session attributes that correspond to the respective requests, and application specific attributes that correspond to the respective requests. Each of the requests is assigned a request priority value. A request may receive the same request priority value as other requests. The requests are queued in a memory based on the request priority values that were assigned to the requests. The queued requests are then serviced in order of request priority so that queued requests assigned higher request priority values are processed before queued requests with lower request priority values.

In another embodiment, an approach is provided in which a number of requests are received from a variety of clients over a computer network. Contextual inputs are identified that correspond to each of the received requests. An extensible markup language (XML) document is created for each of the received requests. Each of the XML documents is transformed using a policy rules file, the transforming resulting in an output XML document corresponding to each of the received requests. The output XML documents are then translated into request priority values and the request priority values are assigned to their respective requests. A number of queues are allocated in a memory with each of the queues corresponding to one of the request priority values. The received requests are then queued to the queue that corresponds to the requests' assigned priority value. The queued requests are serviced (e.g., by a Web server, etc.) in order from the highest request priority queue to the lowest request priority queue.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing components utilized in providing application-aware quality of service (QoS) in network applications;

FIG. 4 is a diagram showing processing of a request by a Priority Calculation Engine to generate a request priority for the request;

FIG. 5 is a flowchart showing steps performed by the Request Manager in processing an incoming request;

FIG. 6 is a flowchart showing steps performed by the Priority Calculation Engine to generate the request priority; and

FIG. 7 is a flowchart showing steps taken by the Queue Manager to monitor and retrieve prioritized requests and pass the requests through a Proxy Request Handler to the Web Server.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

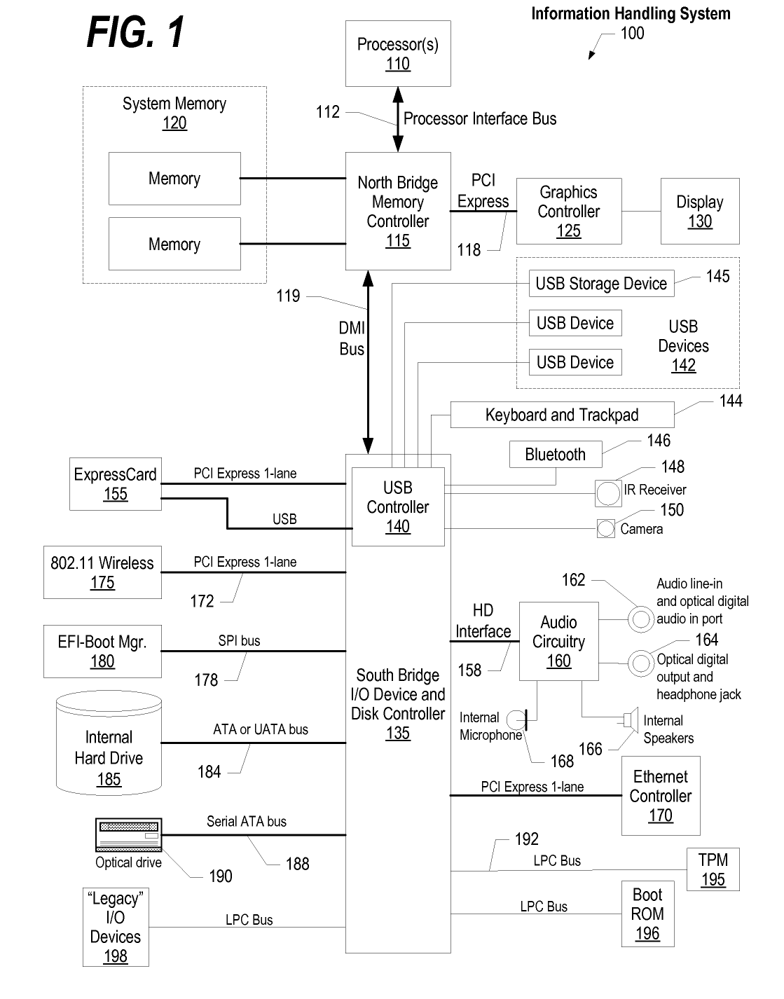

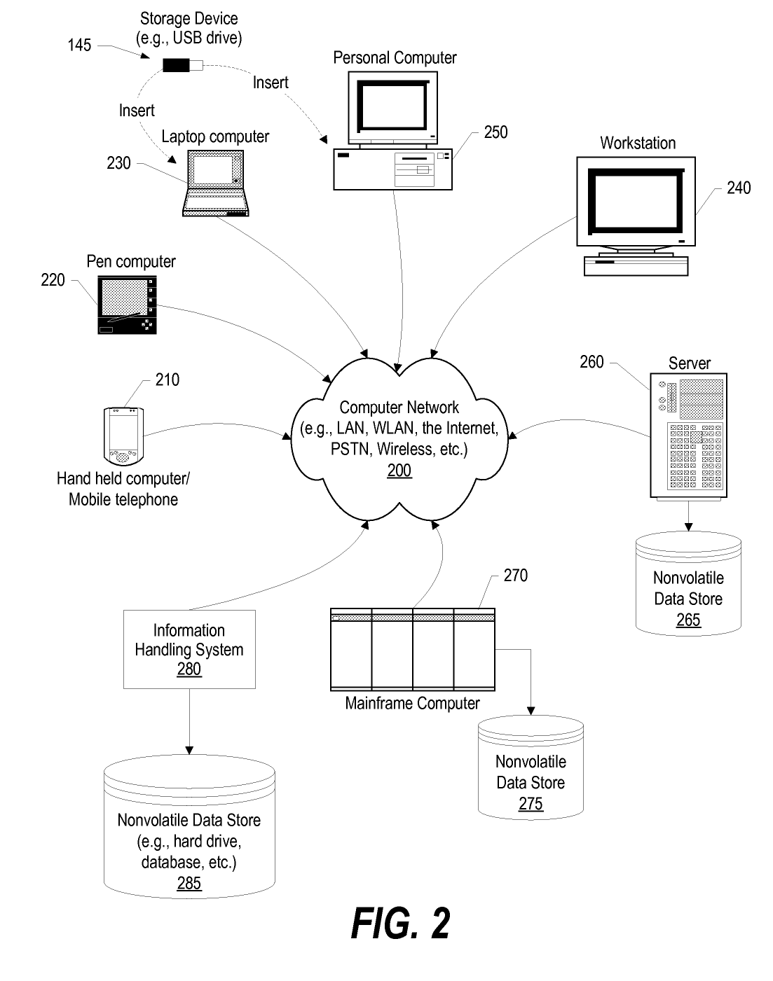

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

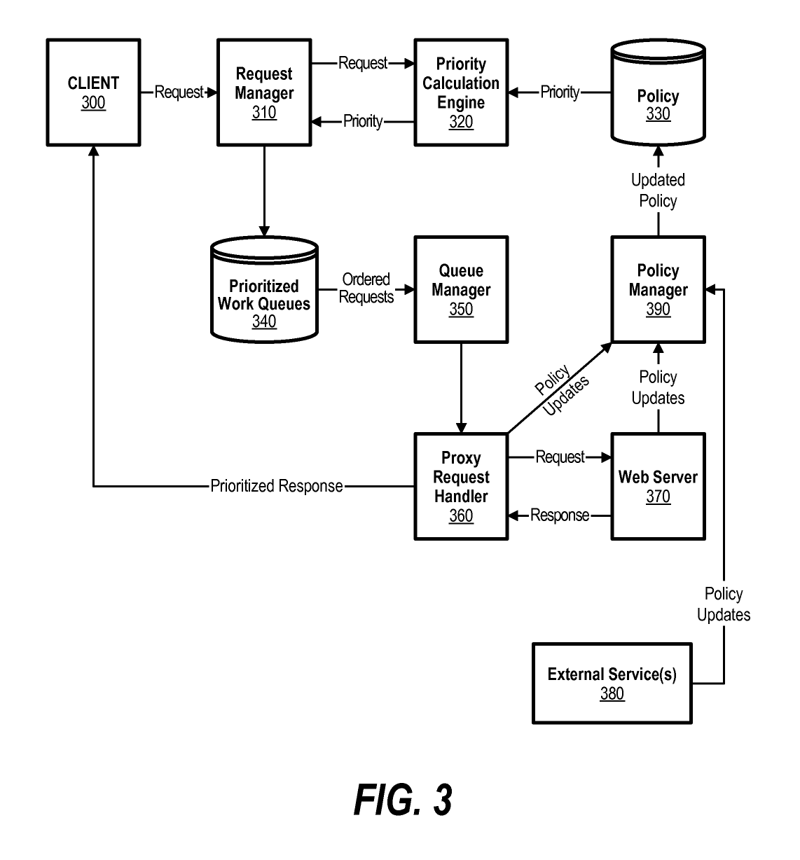

FIG. 3 is a diagram showing components utilized in providing application-aware quality of service (QoS) in network applications. Client 300, such as a client computer system or any information handling system such as those shown in FIG. 2. Client 300 sends a request through a computer network, such as the Internet, to a service provider where it is received by Request Manager 310. The Request Manager passes the received request to Priority Calculation Engine 320. The Priority Calculation Engine computes a request priority for the request based on policy data retrieved from Policy data store 330 and returns the computed request priority back to Request Manager 310.

Request Manager 310 uses the request priority to queue the received request based on the request priority. The request is stored in one of the prioritized work queues (data store 340). Queue Manager 350 has one or more process threads that monitor the prioritized work queues in data store 340. Requests stored in the prioritized work queues are retrieved by the queue manager processes based on the request priorities assigned to the various stored requests. In this manner, requests with higher request priorities are retrieved first followed by requests with lower request priorities. In one embodiment, requests with the same request priority are retrieved in a first-in first-out (FIFO) fashion.

The Queue Manager retrieves the requests from prioritized work queues 340 and removes the request from the queue. The queue manager then passes the request to proxy request handler 360 for proxy processing. Proxy request handler 360 passes the request to Web Application Server 370 for actual processing. The Web Server processing of the request results in a response (e.g., an HTTP response, etc.) that is returned back to proxy request handler 360. In addition, Web Server 370 can update policy 330 that is used to calculate request priorities based on data included in the request, traffic pattern data, etc. In one embodiment, policy updates requested by Web Server 370 are sent directly to Policy Manager 390 which updates policy 330. In another embodiment, the policy updates are encoded in the response that is returned from the Web Server back to Proxy Request Handler 360. In this embodiment, the Proxy Request Handler retrieves the encoded policy update data (e.g., from the HTTP response, etc.) and uses this policy update data to send a policy update to Policy Manager 390. Proxy Request Manager 360 receives the response (e.g., the HTTP response, etc.) from Web Server 370 and then transmits the response back to client 300 via the computer network (e.g., the Internet, etc.).

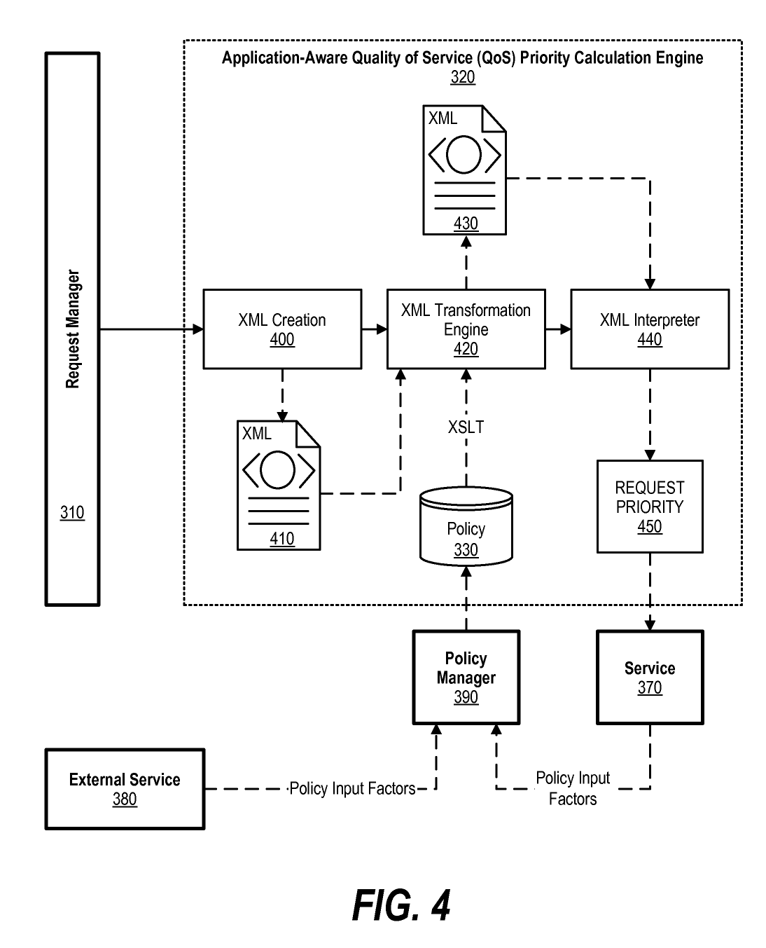

FIG. 4 is a diagram showing processing of a request by a Priority Calculation Engine to generate a request priority for the request. Request Manager 310 transmits the request to Priority Calculation Engine 320 in order to calculate a request priority value for the request. XML Creation process 400 creates XML document 410 using appropriate contextual inputs extracted from the request. The contextual inputs can include elements from the original request, elements from the session, elements corresponding to the client location, etc. An example of an XML document created by process 400 is as follows:

```
?xml version=“1.0” encoding=“UTF-8”?>
<Request>
  <HTTP>
    <RequestLine>
      <Method>GET</Method>
      <URI>/index.html</URI>
      <Version>HTTP/1.1</Version>
    </RequestLine>
  </HTTPRequest>
  <Client>
    <IPAddress>192.168.115.1</IPAddress>
    <Transport>https</Transport>
  </Client>
  <Session>
    <User>scotte</User>
    <Created>1293678625</Created>
    <LastAccessed>1293678630</LastAccessed>
    <AuthenticationLevel>2</AuthenticationLevel>
  </Session>
</Request>
```

Process 420 is an XML Transformation Engine that performs XML transformations from the input XML document (an example of which is shown above) and an extensible stylesheet language transformation (XSLT) policy rules file (policy data store 330). An example of a policy rules file represented in XSLT format is as follows:

```
<?xml version=“1.0” encoding=‘UTF-8’?>
<xsl:stylesheet xmlns:xsl=“http://www.w3.org/1999/XSL/Transform” version=“1.0”>
  <!-- Required to constrain output of rule evaluation -->
  <xsl:output method=“text” omit-xml-declaration=“no” encoding=‘UTF=8’ indent=“no”/>
  <!-- Need this to ensure default text node printing is off -->
  <xsl:template match=“text( )”></xsl:template>
  <!-- Let's make it easier by matching the constant part of our XML name -->
  <xsl:template match=“/Request”>
    <xsl:choose>
      <!-- A resource with the name of /urgent.html has a priority of 1. -->
      <xsl:when test=‘HTTP/RequestLine/URI = “/urgent.html”’>
        <Priority>1</Priority>
      </xsl:when>
      <!-- Anything which has an authentication level of 2 has a priority of 2. -->
      <xsl:when test=‘Session/AuthenticationLevel = “2”’>
        <Priority>2</Priority>
      </xsl:when>
      <!-- All other requests receive a default priority rating of 5 -->
      <xsl:otherwise>
        <Priority>5</Priority>
      </xsl:otherwise>
    </xsl:choose>
  </xsl:template>
</xsl:stylesheet>
```

The output from XML Transformation Engine 420 is XML output file 430 which is used to represent the request priority value in an XML format. An example of output file 430 given the above input XML file 410 and policy rules XSLT file 330 is as follows:

<?xml version=“1.0” encoding=“UTF-8”?>
<Priority>2</Priority>

In the above example, the request priority value is “2.” Process 440 is an XML Interpreter that reads the XML output file to extract the priority value and translates the request priority value from the XML format to request priority value 450 (e.g., numerical, enumeration [high, medium, low] etc.) that is used by the queuing mechanism to queue the request in the appropriate work queue.

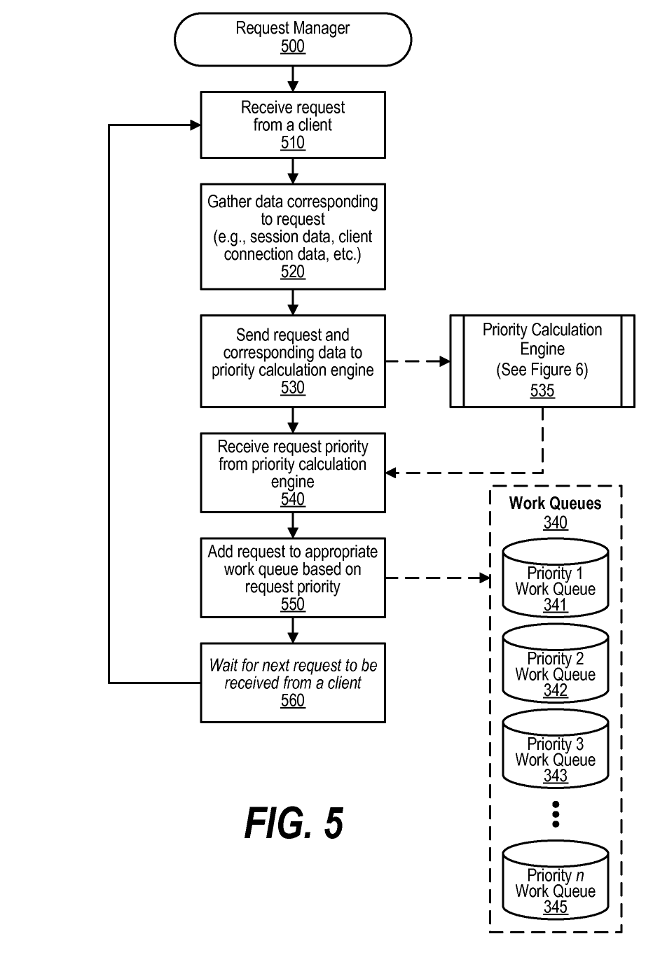

FIG. 5 is a flowchart showing steps performed by the Request Manager in processing an incoming request. Request Manager processing commences at 500 whereupon, at step 510, a request is received from a client. At step 520, the Request Manager gathers data corresponding to the request. This data can include session data, client connection data, and the like. Some of this data may be retrieved directly from the request.

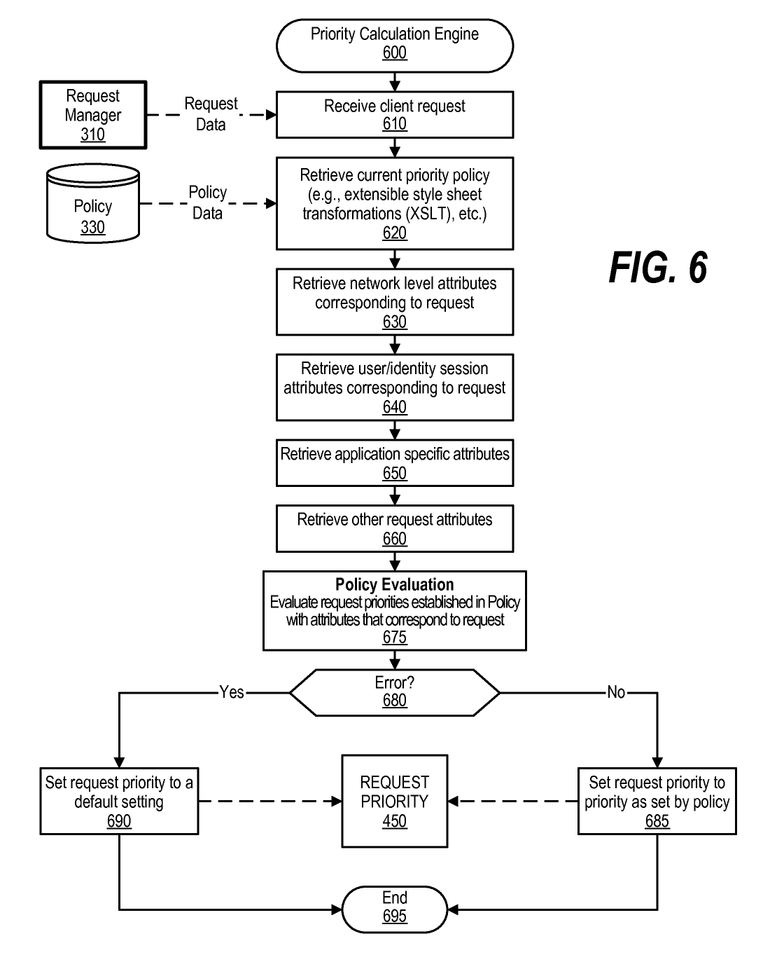

At step 530, the Request Manager sends the request to the Priority Calculation Engine in order to calculate a request priority to assign to the request. At predefined process 535, the Priority Calculation Engine calculates a request priority for the request (see FIG. 6 and corresponding text for further processing details). At step 540, the Request Manager receives the request priority from the Priority Calculation Engine. At step 550, the received request priority is used by the Request Manager to add the request to Work Queues 340. In one embodiment, as shown, a separate work queue is allocated and maintained for each of the various request priorities used by the system. In this manner all requests with a request priority of “1” (e.g., highest priority requests, etc.) are queued in queue 341, those with a request priority of “2” (e.g., next highest priority requests, etc.) are queued in queue 342, lower priority requests are stored in queue 343, with any number of queues ending in lowest request priority requests which are queued in priority n queue 345. Other queuing mechanisms can be utilized based on system requirements. For example, a single queue could be utilized to store all of the requests with the request priority being a field used to sort the queue based on the request priority.

At step 560, the Request Manager waits for the next request to be received by the system. When the next request is received, processing loops back to receive the next request, calculate the request priority, and store the request in the appropriate queue as described above. In other embodiments, the Request manager is a multi-threaded process so that multiple instances of the processing in FIG. 5 could occur concurrently.

FIG. 6 is a flowchart showing steps performed by the Priority Calculation Engine to generate the request priority. Priority Calculation Engine processing commences at 600 whereupon, at step 610, the Priority Calculation Engine receives the client request from Request Manager 310. At step 620, the Priority Calculation Engine retrieves the current priority policy from policy data store 330. An example of a priority policy is an extensible style sheet transformation (XSLT) which is described in further detail at step 420 of FIG. 4 (see FIG. 4 and corresponding text for further processing details).

The Priority Calculation Engine retrieves various attributes corresponding to the received client request. At step 630, the Priority Calculation Engine retrieves network level attributes corresponding to the request. At step 640 the Priority Calculation Engine retrieves user/identity and session attributes corresponding to the request. For example, user/identity attributes might include a user identifier (userid) and group memberships. Examples of session attributes might include a time at which the session was created and that the session was established using one of a number of authentication schemes. At step 650, the Priority Calculation Engine retrieves application specific attributes corresponding to the request. Examples of application specific attributes might include the Universal Resource Locator (URL) requested by the user from the user's Web browser. At step 660, the Priority Calculation Engine retrieves other request attributes as may be defined and implemented for a particular operating environment.

At step 675, the current policy (330) retrieved at step 620 is used to evaluate the attributes that correspond with the client request in order to compute the request priority. Again, for an example using XSLT, see FIG. 4 and corresponding text for further processing details. A determination is made as to whether the policy was able to calculate a request priority using the attributes that correspond to the request (decision 680). If the policy evaluation was successful, then decision 680 branches to the “no” branch whereupon, at step 685, Request Priority 450 is set to the priority calculated during policy evaluation. On the other hand, if an error occurred during policy evaluation, then decision 680 branches to the “yes” branch whereupon, at step 690, Request Priority 450 is set to a default priority value. Priority Calculation Engine processing thereafter ends at 695.

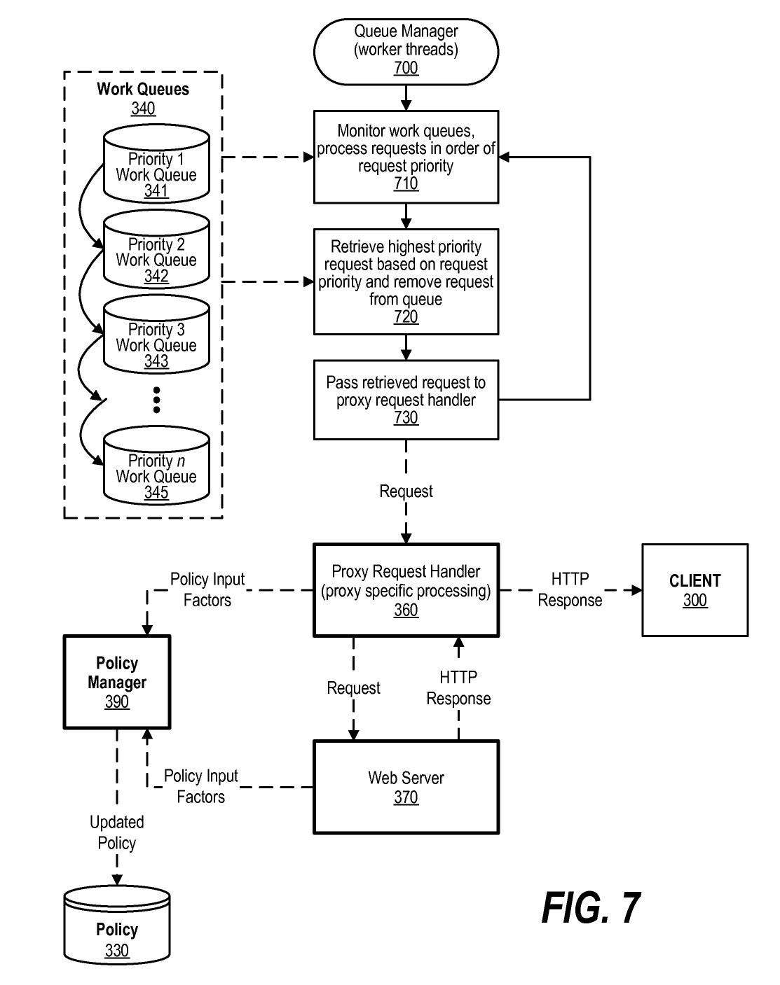

FIG. 7 is a flowchart showing steps taken by the Queue Manager to monitor and retrieve prioritized requests and pass the requests through a Proxy Request Handler to the Web Server. Queue Manager processing commences at 700 whereupon, at step 710, the Queue Manager monitors work queues 340 in order of request priority values. In the example shown, work queues 340 include a number of queues with each of the queues used to queue requests of a particular request priority value. Requests assigned a request priority value of “1” are stored in work queue 341, requests assigned a request priority value of “2” are stored in work queue 342, requests assigned a request priority value of “3” are stored in work queue 343, while requests with the lowest request priority value (n) are stored in work queue 345. During step 710, the queues are checked in order of priority so that requests with higher request priority values are processed before requests with lower request priority values. Using the example shown, requests queued in work queue 341 are processed before requests in other queues. If work queue 341 is empty, then requests queued in work queue 342 are processed before requests in work queues 343 and 345. Likewise, if work queues 341 and 342 are empty, then requests queued in work queue 343 are processed before requests stored in work queue 345. Finally, requests queued in lowest priority queue 345 are processed only if all other work queues (341, 342, and 343) are empty. In one embodiment, if multiple requests are stored in a common work queue then the requests are processed in a FIFO fashion. For example, if three requests are queued in work queue 341, then the request that was first queued in work queue 341 is processed, followed by the second request queued, and finally by the third request queued.

At step 720, the request with the highest request priority value is retrieved and removed from the queue in which it is stored (e.g., queue 341, 342, 343, or 345). Again, if multiple requests are stored in the same queue then the requests are retrieved in a FIFO fashion. At step 730, the retrieved request is passed to the proxy request handler for further processing. Meanwhile, the Queue Manager process loops back to step 710 to continue monitoring and retrieving requests based on the request priority values.

Proxy Request Handler 360 receives the request from the Queue Manager and performs proxy specific handling. The Proxy Request Handler then passes the request to Web Server 370 for actual processing of the request. The Web Server prepares a response (e.g., an HTTP Response, etc.). In one embodiment, the Web Server returns the response to client 300. However, in another embodiment as shown in FIG. 7, the Web Server returns the response to Proxy Request Handler 360 and the Proxy Request Handler returns the response to client 300. During processing of the request, Web Server may determine that one or more policy input factors should be adjusted. The policy input factors can be transmitted to Policy Manager 390 and the Policy Manager will use the policy input factors to update policy 330. In another embodiment, Web Server 370 encodes policy input factors in the response and, in this embodiment, the Proxy Request Handler extracts the policy input factors from the response and transmits the policy input factors to Policy Manager 390 which in turn updates policy 330.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method performed by an information handling system comprising:
receiving, over a computer network, a plurality of requests at a network adapter from a plurality of clients;
calculating, using a processor, a plurality of request priority values pertaining to the received requests, wherein one of the request priority values is assigned to each of the received requests, and wherein the calculation is based on one or more attributes that correspond to the respective requests;
queuing the received requests in a memory, the queuing being based on the assigned request priority values; and
servicing the queued requests in order from a highest request priority value to a lowest request priority value.

2. The method of claim 1 wherein the calculating of the request priority values further comprises:
retrieving request data pertaining to the received requests, wherein the request data includes the one or more attributes;
comparing the request data to a policy; and
generating the request priority values based on the comparison.

3. The method of claim 2 wherein the retrieving of the request data further comprises:
retrieving one or more network level attributes corresponding to each of the received requests;
retrieving one or more session attributes corresponding to each of the
retrieving one or more application specific attributes corresponding to each of the received requests.

4. The method of claim 3 wherein the queuing further comprises:
allocating a plurality of queues in the memory, wherein each of the plurality of queues corresponds to one of the request priority values; and
storing the received requests assigned to a common priority value in the allocated queue corresponding to the common priority value.

5. The method of claim 4 further comprising:
monitoring each of the allocated queues using one or more queue manager processes;
identifying a highest priority queue where at least one of the queued requests is stored; and
retrieving one of the queued requests from the identified queue.

6. The method of claim 5 further comprising:
passing the retrieved request to a server;
processing, by the server, the retrieved request, the processing resulting in a response;
identifying one of the clients that corresponds to the retrieved request; and
transmitting the response, over the computer network, to the identified client.

7. The method of claim 6 further comprising:
identifying one or more policy input factors based on the processing of the
updating the policy based on the identified policy input factors.

8. A method performed by an information handling system comprising:
receiving, over a computer network, a plurality of requests at a network adapter from a plurality of clients;
identifying a plurality of contextual inputs corresponding to each of the received requests;
creating an extensible markup language (XML) document corresponding to each of the received requests, wherein the XML document is created using the identified contextual inputs corresponding to the respective requests;
transforming each of the XML documents using a policy rules file, the transforming resulting in an output XML document corresponding to each of the received requests;
translating the output XML documents into a plurality of request priority values, wherein the request priority values are assigned to their respective requests;
allocating a plurality of queues in the memory, wherein each of the plurality of queues corresponds to one of the request priority values;
queuing the received requests assigned to a common priority value in the allocated queue corresponding to the common priority value; and
servicing the queued requests in order from a highest request priority queue to a lowest request priority queue.

9. The method of claim 8 wherein the identified contextual inputs are selected from a group consisting of one or more network level attributes corresponding to each of the received requests, one or more session attributes corresponding to each of the received requests, and one or more application specific attributes corresponding to each of the received requests, and wherein the method further comprises:

10. The method of claim 9 further comprising:
passing the retrieved request to a server;
processing, by the server, the retrieved request, the processing resulting in a response;
identifying one of the clients that corresponds to the retrieved request; and
transmitting the response, over the computer network, to the identified client.

11. The method of claim 10 wherein the policy rules file is an extensible stylesheet language transformation (XSLT) file and wherein the method further comprises:
identifying one or more policy input factors based on the processing of the retrieved request; and
modifying the XSLT file based on the identified policy input factors.
